(19) United States
(12) Patent Application Publication
(10) Pub. No.: US 2006/0180515 A1
(43) Pub. Date: Aug. 17, 2006

(54) Certification information generating apparatus and certification apparatus

(75) Inventors: Tetsuya Kimura, Kanagawa (JP); Tadashi Shimizu, Kanagawa (JP); Kensuke Ito, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/243,970

(22) Filed: Oct. 6, 2005

(30) Foreign Application Priority Data
Oct. 7, 2004 (JP) P2004-294497

(51) Int. Cl. B07C 5/00

(52) U.S. Cl. 209/547

(57) ABSTRACT

A certification information generating apparatus includes: a feature quantity generator, for generating a feature quantity related to a paper medium on which identification information is printed; and a database generator, for generating a database wherein the feature quantity and the identification information are correlated with each other. The database that is generated is employed for a predetermined process related to certification of a paper medium.

### BACKGROUND OF THE INVENTION

1. Field of the Invention

The present invention relates to a certification information generating apparatus for certifying a paper medium, and a certification apparatus.

2. Description of the Related Art

Recently, as printing techniques have been developed, high resolution printed matter has become easily available. Against this background, it is feared that accurate forgeries of notes, for example, may be produced. According to a conventional counterfeit note detection method, the presence/absence of information and the material that should be included in an authentic note, in advance, is examined. For example, using intaglio printing, tiny raised portions are formed on an authentic note, and the presence/absence of the tiny raised portions on a detection line are sequentially examined. The pattern of all tiny raised portions detected is compared with the pattern on an authentic note, and when, sequentially, 10 mm or more of the entire pattern matches a corresponding portion of an authentic note, a target note is determined to be authentic. In other cases, the target note is determined not to be authentic.

As described above, according to the conventional counterfeit printed matter detection method, a material, such as a tiny raised portion, unique to printed matter, is formed in advance and is detected. Therefore, when a counterfeiter copies this material directly, production of a forgery that is determined to be authentic would be possible.

### SUMMARY OF THE INVENTION

The present invention provides a certification information generating apparatus and a certification apparatus that can improve certification strength related to the forgery of printed matter.

According to one embodiment of the present invention, A certification information generating apparatus includes: a feature quantity generator that generates a feature quantity related to a paper medium on which identification information is printed; and a database generator that generates a database in which the feature quantity and the identification information are correlated with each other, wherein the database that is generated is employed for a predetermined process related to certification of a paper medium.

According to an embodiment of the invention, a certification apparatus includes: an acquisition unit that obtains identification information printed on a paper medium to be certificated; a feature quantity acquisition unit that obtains from a database in which a feature quantity and the obtained identification information are correlated with each other, information for the feature quantity that is correlated with the identification information; a feature quantity generator that generates a feature quantity related to the paper medium to be certificated, wherein the obtained information for the feature quantity and the information for the generated feature quantity are employed for a predetermined processsing related to certification.

According to an embodiment of the invention, a certification information generation method, includes the steps of: generating a feature quantity related to a paper medium on which identification information is printed; and generating a database in which the feature quantity and the identification information are correlated with each other, wherein the generated database is employed for a predetermined processing related to certification of the paper medium.

According to an embodiment of the invention, a method for controlling a certification apparatus that employs a database, generated by a certification information generation apparatus, that includes a feature quantity generator for generating a feature quantity related to a paper medium on which identification information is printed, and a database generator for generating a database in which the feature quantity and the identification information are correlated with each other, enables the certification apparatus to perform the steps of: obtaining identification information printed on a paper medium to be certificated; obtaining, from the database, information for the feature quantity that is correlated with the obtained identification information; and generating a feature quantity related to the paper medium to be certificated, wherein the information obtained for the feature quantity and the information for the feature quantity that is generated are employed for a predetermined processing related to certification.

According to one more embodiment of the invention, a program product that enables a computer to generate certification information includes: software instructions for enabling the computer to perform predetermined operations; and a computer-readable recording medium bearing the software instructions, wherein the software instructions include the steps of generating a feature quantity related to a paper medium on which identification information is printed, and generating a database wherein the feature quantity and the identification information are correlated with each other; and the generated database is employed for a predetermined processing related to certification of the paper medium.

According to an embodiment of the invention, a program product, which enables a certification apparatus including a computer to employ a database generated by a certification information generation apparatus that includes a feature quantity generator, for generating a feature quantity related to a paper medium on which identification information is printed, and a database generator, for generating a database in which the feature quantity and the identification information are correlated with each other, includes: a software instructions for enabling the computer to perform predetermined operations; and a computer-readable recording medium bearing the software instructions, wherein the software instructions enables the computer to perform the steps of obtaining identification information printed on a paper medium to be certificated, obtaining, from the database, information for the feature quantity that is correlated with the obtained identification information, and generating a feature quantity related to the paper medium to be certificated, and wherein the obtained information for the feature quantity and the generated information for the feature quantity are employed for a predetermined processing related to certification.

### BRIEF DESCRIPTION OF THE DRAWINGS

FIG. 1 is a block diagram showing the configuration of a system for comparison according to one embodiment of the present invention.

FIG. 2 is a functional block diagram showing example processing performed by a certification information generating apparatus according to the embodiment of the present invention.

FIG. 3 is an explanatory diagram showing an example setup for a reading area.

FIG. 4 is an explanatory diagram showing example registered contents for a database.

FIG. 5 is a functional block diagram showing example processing performed by a certification apparatus according to the embodiment of the present invention.

FIG. 6 is an explanatory diagram showing an example correlation operation.

FIGS. 7A to 7C are explanatory diagrams showing example results for the correlation operation.

### DESCRIPTION OF THE EMBODIMENT

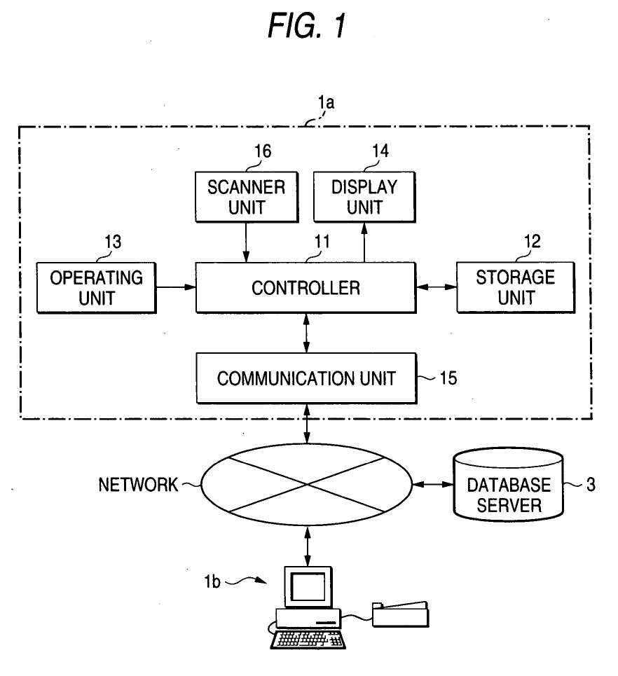

One embodiment of the present invention will now be described while referring to the drawings. As shown in FIG. 1, a certification system according to the embodiment of the present invention includes a certification information generating apparatus 1a, a certification apparatus 1b and a database server 3. The certification information generating apparatus 1a and the certification apparatus 1b each includes a controller 11, a storage unit 12, an operating unit 13, a display unit 14, a communication unit 15 and a scanner 16. In the following explanation, this system is employed to prevent the forgery of notes.

The controller 11 can be provided by a CPU (Central Processing Unit), for example, and performs the processing based on a program stored in the storage unit 12. In this embodiment, the program executed by the controller 11 differs for the certification information generating apparatus 1a and the certification apparatus 1b. Therefore, the contents of the processing performed by the controller 11 will be explained later, separately, for the individual apparatuses.

The storage unit 12 is a storage device, such as a RAM (Random Access Memory) or a computer-readable storage medium that includes a disk device, such as a hard disk. A program to be executed by the controller 11 is stored in the storage unit 12. The storage unit 12 also serves as a work memory in which various information required for the process of the controller 11 is stored.

The operating unit 13 is, for example, a keyboard or a mouse, and outputs the contents of the instruction to a user of the controller 11. The display unit 14 is, for example, a display device, and presents information for the user in accordance with an instruction received from the controller 11. The communication unit 15 is, for example, a network interface, and is connected via a network to an external device. In accordance with an instruction received from the controller 11, the communication unit 15 transmits various data to instructed addresses. Further, the communication unit 15 receives data from an external device via a network, and transmits the data to the controller 11.

The scanner 16 is a general, flat-bed scanner. The scanner 16 may also include a so-called automatic document feeder (ADF) that feeds documents sheet by sheet. Furthermore, the entire flat-bed scanner is not always necessary, and the scanner 16 may include a combination of a photoelectric sensor (e.g., a CCD line sensor) that is used for a flat-bed scanner, and illumination portions, which are arranged on line for scanning the read position for a document. Further, the scanner 16 need not also be a line sensor, and may be a combination of a CCD area sensor and of an illumination portion that illuminates the viewing field of the CCD area sensor. In addition, the scanner 16 may, for example, be a digital camera. Moreover, an image reading method may be a method for a reading light that is reflected from a target paper medium, or a method for a reading light that is transmitted through a paper medium.

The database server 3 includes a network interface, a controller and a storage device (none of them shown). In accordance with a database registration instruction received through the network interface, the database server 3 registers the instructed registration contents in the storage device. Furthermore, in accordance with a database read instruction received through the network interface, the database server 3 reads, from the storage device, data that are correlated with key information included in the read instruction, and forwards the data to a read instruction transmission source.

The contents of the processing performed by the controller 11 will now be described. Since, as has already been described, the processing performed by the controller 11 differs from the processing performed in the certification information generation apparatus 1a and the processing performed in the certification apparatus 1b, the processing for them will be explained separately.

First, the processing performed in the certification information generation apparatus 1a will be explained. It should be noted that identification information (symbols and numbers consisting of alphabetical characters and numerals) called a “symbolic number” is provided for a note. The symbolic number is not always unique (unique meaning that no note has the same symbolic number) . In this embodiment, this symbolic number (e.g., a number printed in advance, for example, on printed matter to be certified) is employed as identification information for the present invention.

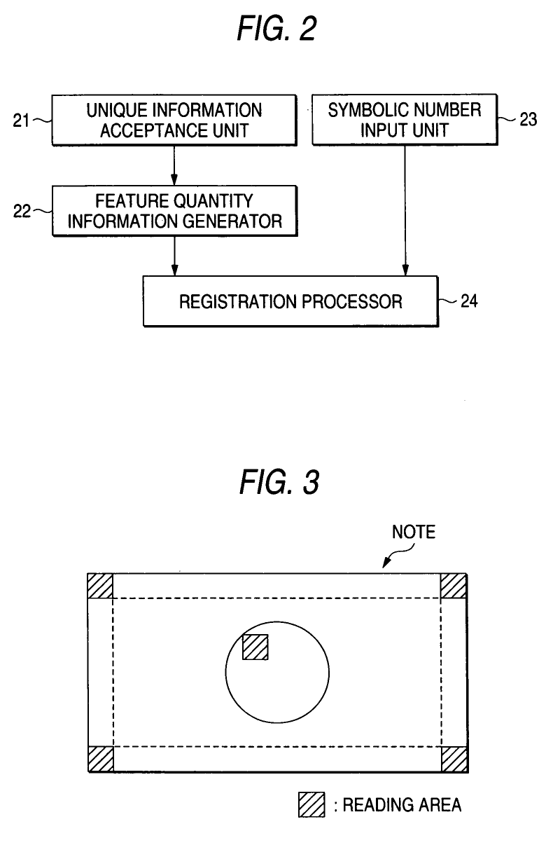

As shown in FIG. 2, the program executed by the controller 11 of the certification information generation apparatus 1a includes the functions of a unique information acceptance unit 21, a feature quantity information generator 22, a symbolic number input unit 23 and a registration processor 24. That is, the certification information generation apparatus 1a of this embodiment generates, for each note to be certified, a feature quantity unique to a paper medium that is used for this note, and registers the unique feature quantity in the database server 3, in correlation with a symbolic number, which is identification information printed on the note. The database thus generated is employed for a predetermined process related to the certification of a note.

Furthermore, in this embodiment, the unique feature quantity is assumed to be a feature quantity related to a paper fiber pattern in at least one predetermined area of a paper medium. That is, a paper medium has a structure formed by the intertwining of a fiber material that is a common paper material. The intertwining pattern of the fiber material (a paper fiber pattern) has a unique randomness, and can be used as information for identifying each paper medium. Further, in order to forge a paper fiber pattern, the fine structure must be reproduced while the thickness and the length of the paper fiber are aligned. This is actually impossible.

Specifically, a comparison method using a paper fiber pattern (so to speak, the roughness of solid portions without any printing thereon) is as follows. Image data representing a paper fiber pattern are recorded as a feature quantity (hereinafter called a registered feature quantity) . And a correlation operation is performed for the image data, which represent the paper fiber pattern in the predetermined area of the paper medium to be compared, and the registered feature quantity, and a correlation value is obtained. When the correlation value exceeds a predesignated threshold value, it is determined that the comparison has been successful (i.e., the paper medium is the same as the one that is stored). When the correlation value is less than the threshold value, it is determined that the comparison has failed (i.e., the paper medium to be compared differs from the paper medium that is stored). The contents of the correlation operation used to determine the identity of image data are as follows.

The contents of the correlation operation for two sets of image data F and G for a total of N pixels are defined by the following expression (1), using brightness values fi and gi (i is an integer of 0 to N−1) for the pixels of the individual image data sets.

$$F = {\{ {f}_{i} \}}_{i = 0}^{N - 1} G = {\{ {g}_{i} \}}_{i = 0}^{N - 1} \\ correlation value = \frac{{\sum }_{n = 0}^{N - 1} ( {f}_{n} - {f}_{AVE} ) ( {g}_{n} - {g}_{AVE} )}{\sqrt{{\sum }_{n = 0}^{N - 1} {( {f}_{n} - {f}_{AVE} )}^{2}} \sqrt{{\sum }_{n = 0}^{N - 1} {( {g}_{n} - {g}_{AVE} )}^{2}}} \qquad ( 1 )$$

In this expression, f_{AVE} denotes an average value for the brightness values of the individual pixels of the image data F, and g_{AVE} denotes an average value for the brightness values of the individual pixels of the image data G.

Of course, as in the embodiment, notes are usually stored in purses. There are various forms in which notes are stored in purses, and notes maybe folded. Further, during circulation, parts of notes may be damaged or destroyed, and in this case, so long as this damage or destruction causes no difficulties when used, usually, the notes are circulated. That is, in order to cope with difficulties, such as the folding of, writing on or damaging of notes, it is preferable that multiple areas for reading a paper fiber pattern be established to be used for calculating a feature quantity. Furthermore, in this case, the predetermined areas include, for example, at least one area near the corner of a note that is a paper medium, or an area at the end (FIG. 3). As described above, a reading area is designated at a position, along which the note tends to be folded, at least a predetermined distance from line segments that connect a point ¼ or ⅓ and a point ½ the direction of the height and the direction of the width.

In addition, the number of notes to be issued is about ten billion, and when, in order to identify an individual note, a correlation operation is performed for at least ten billion registered feature quantities that are stored in the database and the paper fiber pattern of the note to be compared, the comparison could not be completed within an appropriate period of time. Especially, the comparison apparatus 1b in this embodiment can not be practically employed for an application such that an apparatus 1b is installed, for example, in a retail store to detect counterfeit notes at that place. Therefore, in this embodiment, the symbolic number of a note is employed to narrow down and search for the registered feature quantity. The contents of this processing will now be explained.

The unique information acceptance unit 21 permits the scanner 16 to read at least one set of image data in a predesignated area (a predetermined area) of a note. The predetermined area is an area (blank at first) of a note bearing no printing, and includes, for example, as shown in FIG. 3, at least one area near a corner of a note or at the end. The unique information acceptance unit 21 reads image data at a predetermined resolution (e.g., 400 dpi) and using a predetermined gray scale (e.g., an 8-bit gray scale).

The feature quantity information generator 22 calculates and generates a feature quantity based on at least one set of image data that are read by the unique information acceptance unit 21. Specifically, the feature quantity is an array of sets of image data that are arranged in a predesignated order (called a registration order). Further, the feature quantity information generator 22 may encrypt the information for the feature quantity using a predetermined secret key (called a generation side secret key). The feature quantity information generator 22 outputs the information for the feature quantity to the registration processor 24.

The symbolic number input unit 23 receives, through the operating unit 13, a symbolic number entered by a user, and transmits the symbolic number to the registration processor 24. In addition, the symbolic number input unit 23 may permit the scanner 16 to read the printed position of the symbolic number on a note, and to generate information for a symbolic number by performing a widely known OCR (Optical Character Recognition) process. Further, the symbolic number input unit 23 may employ the generation side secret key to encrypt the obtained information for the symbolic number.

The registration processor 24 correlates the feature quantity received from the feature quantity information generator 22 and the information for the symbolic number received from the symbolic number input unit 23 (the feature quantity and the information for the symbolic number may also be encrypted), and issues a registration instruction to the database server 3.

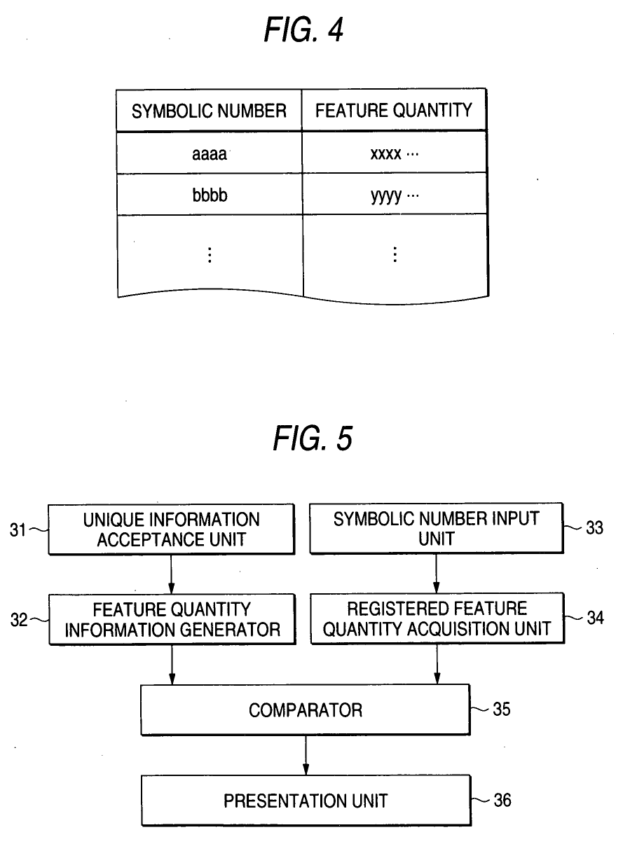

Thus, as shown in FIG. 4, a table wherein the symbolic number and the information for the feature quantity (the registered feature quantity) are correlated with each other is stored in the database server 3. In this embodiment, one of the characteristics is that not always is one registered feature quantity correlated with a specific symbolic number. This is because a plurality of areas for reading image data, which are sources for individual registered feature quantities, may be present for individual notes, and also because a plurality of notes whereon the same symbolic number is printed may be present.

It should be noted that the feature quantity information generator 22 may output, in correlation with each feature quantity, information (area specification information) for specifying an area for reading image data that is a source for performing the operation for the feature quantity. In this case, the registration processor 24 registers, in the database server 3, the feature quantity, the area specification information and the information for the symbolic number in correlation with each other. The area specification information may also be encrypted.

The operation of the controller 11 in the certification apparatus 1b of this embodiment will now be explained. As shown in FIG. 5, the program executed by the controller 11 of the certification apparatus 1b includes the functions of a unique information acceptance unit 31, a feature quantity information generator 32, a symbolic number input unit 33, a registered feature quantity acquisition unit 34, a comparator 35 and a presentation unit 36.

The unique information acceptance unit 31 permits the scanner 16 to read at least one set of image data in a predesignated area (a predetermined area) of a note to be certified (a certification target note). The predetermined area here is the same area as that for image data that are used as a source for the feature quantity operation of the certification information generation apparatus 1a, or an area (called an extended area) that includes this area.

The feature quantity information generator 32 calculates and generates a feature quantity using at least one set of image data that are read by the unique information acceptance unit 31. Specifically, the feature quantity may also actually be image data that are read.

The symbolic number input unit 33 receives, through the operating unit 13, a symbolic number entered by a user. Further, the symbolic number input unit 33 may permit the scanner 16 to read the printed position of the symbolic number on a note, and may generate information for the symbolic number using a widely known OCR (Optical Character Recognition) process.

The registered feature quantity acquisition unit 34 employs, as key information, the information for the symbolic number generated by the symbolic number input unit 33, and obtains, from the database server 3, information for the registered feature quantity that is correlated with the key information. When the information for the registered feature quantity is encrypted, a public key corresponding to the generation side secret key is employed to decode the information for the registered feature quantity.

The comparator 35 compares (performs a correlation operation), for example, the registered feature quantity obtained by the registered feature quantity acquisition unit 34 with the feature quantity generated by the feature quantity information generator 32, and examines whether the correlation value exceeds a predetermined threshold value. Basically, the comparator 35 need only compare the generated feature quantity and the registered feature quantity in their order of registration.

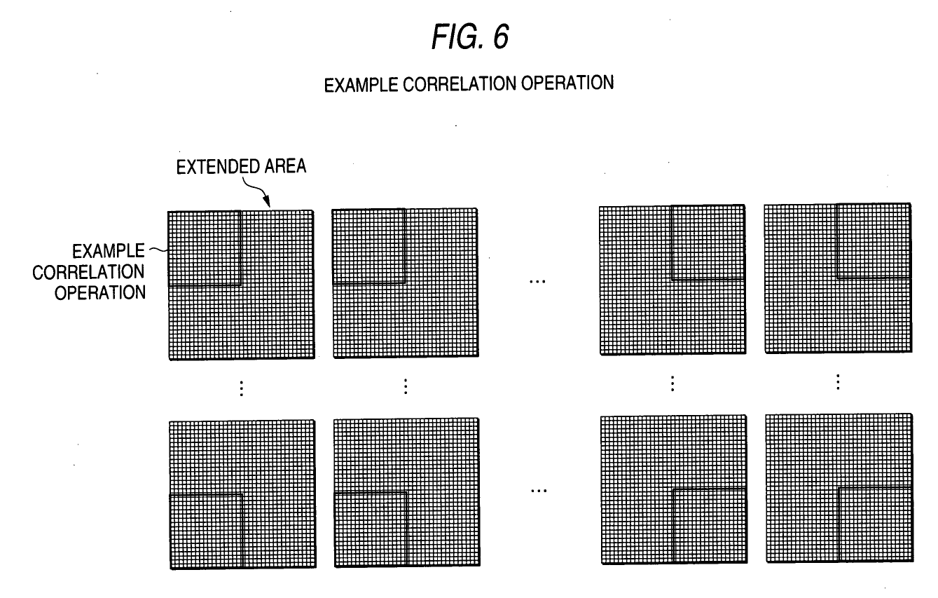

However, the location for the reading of the image data that is the source for the feature quantity does not always match for the registration of the feature quantity and for the comparison. Further, usually, the image to be compared is degraded by deterioration of the note (e.g., dirt accumulation). Therefore, in the raster line order (by repetitiously scanning one line in the area from the upper left corner to the right, and then scanning the next line from the left to the right), the comparator 35 scans the size of image data (N0×M0 pixels, N0<N1, M0<M1) used for a feature quantity operation in each extended area (defined as N1×M1 pixels) that is accepted by the unique information acceptance unit 31. Then, at each scanning location, a correlation value for a registered feature quantity that is consonant with image data at the scanning location is calculated (FIG. 6).

Further, a plurality of correlation values at the individual correlation values are employed to obtain a normalized score using the following expression (2).
normalized score=(maximum correlation value−average value of correlation values)/standard deviation of correlation value (2)

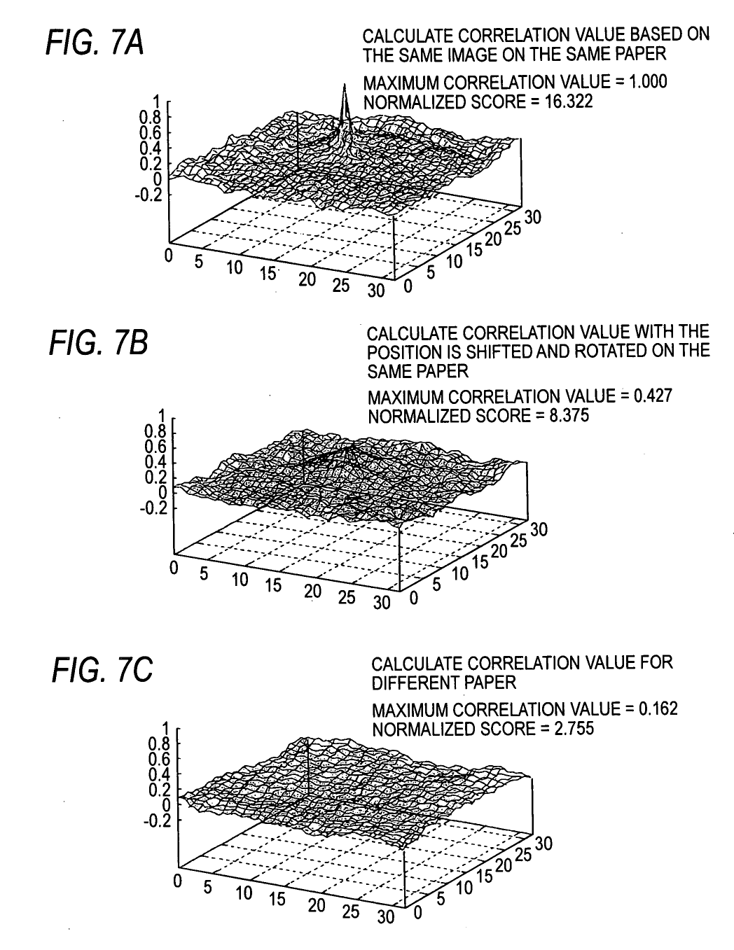

Specifically, an example wherein the normalized score is calculated is shown in FIGS. 7A to 7C. It should be noted that meshes in FIGS. 7A to 7C are graphs of correlation values at the individual scanning positions.

The comparator 35 determines whether the maximum correlation value obtained and the normalized score exceed predesignated values. When these values exceed the threshold values, it is determined that a certification target note is an authentic note (a registered note). In a case wherein the registered feature quantity acquisition unit 34 has obtained a plurality of registered feature quantities (i.e., there are a plurality of notes consonant with one symbolic number), when one of the normalized scores and one of the maximum correlation values that are obtained by the correlation operation performed relative to these registered feature quantities exceed the threshold values, it is determined that the certification target note is an authentic note (a registered note).

It should be noted that the reading positions for the individual registered feature quantities can be identified in accordance with the registration order. However, when the information (the area specification information) for specifying the individual reading positions and the registered feature quantity are registered in the database server 3 in correlation with each other, the area specification information may be employed to identify the reading positions for the individual registered feature quantities. Also in this case, when the area specification information is encrypted, a public key corresponding to the generation side secret key is employed to decode the area specification information.

The presentation unit 36 outputs and displays, on the display unit 14, the determination results obtained by the comparator 35.

Since the certification system of this embodiment has the above described configuration, the system is operated, for example, as follows. It is assumed that the certification information generation apparatus 1a has been installed in a note production base, and that the certification apparatus 1b has been installed, for example, in a retail store.

In the note production base, a symbolic number is printed on a note, and also a feature quantity, which is related to the paper for a note that is consonant with each symbolic number, is calculated. In this case, the feature quantity is an image of a paper fiber pattern in a predetermined area of a note. The certification information generation apparatus 1a reads images of paper fiber patterns in a plurality of predetermined areas on a note, and registers data for the individual images as registered feature quantities in the database server 3, in correlation with a symbolic number and information specifying the reading areas.

Whereas, in a retail store the certification apparatus 1b is employed to read that portion of a note wherein a symbolic number is printed and areas (extended areas corresponding to the predetermined areas) correlated with a plurality of locations, when the reading of the entire face of a note is acceptable, the entire face of the note may be read and the individual areas may then be extracted.

The certification apparatus 1b performs an optical character recognition process for image data that are read, and identifies a symbolic number. Then, a registered feature quantity correlated with the symbolic number (and information for specifying a reading area) is obtained from the database server 3. Following this, the certification apparatus 1b performs a correlation operation for the image data in each extended area that has been read, and for the registered feature quantity that is correlated with the information for a specified reading area that is included in the extended area. As previously described, the correlation operation is a calculation to obtain a normalized score and a maximum correlation value for an extended area.

When there are a plurality of registered feature quantities that are correlated with the symbolic number and that are correlated with the information specifying the reading area that is included in the extended area, the certification apparatus 1b performs the correlation operation for each registered feature quantity and the image data in the extended area.

In this manner, the certification apparatus 1b obtains a plurality of correlation operation results. And when the target note is determined to be authentic, based on at least one of these correlation operation results, the certification apparatus 1b displays a message for an authentic note.

It should be noted that the note may be determined to be authentic only when the note is regarded as authentic based on predesignated n or more of a plurality of correlation operation results. Furthermore, when it is not determined that the note is authentic, that effect may be displayed.

In the above explanation, the database server 3 is regarded as being capable of communicating through a network. However, instead of this, a database wherein, for example, registered feature quantities are stored may be stored on a recording medium, such as a DVD (Digital Versatile Disk), and the certification apparatus 1b may read, from the database, a registered feature quantity that corresponds to a symbolic number. In this case, the contents of the DVD are updated consonant with a predetermined timing.

According to this embodiment, since the feature quantity, which is unique to paper that is difficult to forge, and identification information, which is provided for a certification target, are employed to narrow down and search for a registered feature quantity, a certification strength as related to printed matter forgery can be improved, and a practical certification speed can be attained.

The present invention has been described in detail by referring to the specific embodiment. However, it will be obvious to one having ordinary skill in the art that the present invention can be variously modified, or arranged, without departing from the spirit and scope of the present invention.

The present application is based on Japanese Patent Application (Patent Application No. 2004-294497) filed on Oct. 7, 2004, and the contents of the application are included as a reference in this specification.

What is claimed is:

1. A certification information generating apparatus comprising:
a feature quantity generator that generates a feature quantity related to a paper medium on which identification information is printed; and
a database generator that generates a database in which the feature quantity and the identification information are correlated with each other,
wherein the database that is generated is employed for a predetermined process related to certification of a paper medium.

2. The certification information generating apparatus according to claim 1,
wherein said feature quantity related to said paper medium is a feature quantity correlated with a pattern of a paper fiber for at least one predetermined area on said paper medium.

3. The certification information generating apparatus according to claim 2,
wherein said predetermined area includes at least one of an area near a corner of said paper medium and an area at an end of said paper medium.

4. A certification apparatus comprising:
an acquisition unit that obtains identification information printed on a paper medium to be certificated;
a feature quantity acquisition unit that obtains from a database in which a feature quantity and the obtained identification information are correlated with each other, information for the feature quantity that is correlated with the identification information;
a feature quantity generator that generates a feature quantity related to the paper medium to be certificated,
wherein the obtained information for the feature quantity and the information for the generated feature quantity are employed for a predetermined processsing related to certification.

5. A certification information generation method, comprising the steps of:
generating a feature quantity related to a paper medium on which identification information is printed; and
generating a database in which the feature quantity and the identification information are correlated with each other,
wherein the generated database is employed for a predetermined processing related to certification of the paper medium.

6. A method for controlling a certification apparatus that employs a database, generated by a certification information generation apparatus, that includes a feature quantity generator for generating a feature quantity related to a paper medium on which identification information is printed, and a database generator for generating a database in which the feature quantity and the identification information are correlated with each other, the method enabling the certification apparatus to perform the steps of:
obtaining identification information printed on a paper medium to be certificated;
obtaining, from the database, information for the feature quantity that is correlated with the obtained identification information; and
generating a feature quantity related to the paper medium to be certificated,
wherein the information obtained for the feature quantity and the information for the feature quantity that is generated are employed for a predetermined processing related to certification.

7. A program product that enables a computer to generate certification information comprising:
software instructions for enabling the computer to perform predetermined operations; and
a computer-readable recording medium bearing the software instructions,
wherein the software instructions include the steps of
generating a feature quantity related to a paper medium on which identification information is printed, and
generating a database wherein the feature quantity and the identification information are correlated with each other; and
the generated database is employed for a predetermined processing related to certification of the paper medium.

8. A program product, which enables a certification apparatus including a computer to employ a database generated by a certification information generation apparatus that includes a feature quantity generator, for generating a feature quantity related to a paper medium on which identification information is printed, and a database generator, for generating a database in which the feature quantity and the identification information are correlated with each other, comprising:
a software instructions for enabling the computer to perform predetermined operations; and
a computer-readable recording medium bearing the software instructions,
wherein the software instructions enables the computer to perform the steps of
obtaining identification information printed on a paper medium to be certificated,
obtaining, from the database, information for the feature quantity that is correlated with the obtained identification information, and
generating a feature quantity related to the paper medium to be certificated, and
wherein the obtained information for the feature quantity and the generated, information for the feature quantity are employed for a predetermined processing related to certification.
